(19) United States
(12) Patent Application Publication
(10) Pub. No.: US 2011/0236871 A1
(43) Pub. Date: Sep. 29, 2011

(54) Recombinant Knowledge Assimilation

(75) Inventor: John N. Carbone, Garland, TX (US)

(73) Assignee: Raytheon Company, Waltham, MA (US)

(21) Appl. No.: 13/069,811

(22) Filed: Mar. 23, 2011

Related U.S. Application Data
(60) Provisional application No. 61/317,164, filed on Mar. 24, 2010.

(51) Int. Cl. G09B 7/00

(52) U.S. Cl. 434/322

(57) ABSTRACT

In certain embodiments, a method includes accessing one or more content that each satisfy one or more parameters of a search request. The method further includes determining a plurality of knowledge components associated with the received one or more content objects, the plurality of content objects including a first knowledge component comprising a first discrete portion of information extracted from the one or more content objects and a second knowledge component comprising a second discrete portion of information extracted from the one or more content objects. The method further includes receiving first and second importance factors indicating the relative importance of the first and second knowledge components, respectively. The method further includes determining, based on the first and second importance factors, an association factor indicating the degree to which the first and second knowledge components are related to one another. The method further includes storing the first knowledge component, the second knowledge component, and the determined association as a new content object.

### RELATED APPLICATIONS

This application claims the benefit under 35 U.S.C. §119(e) of the priority of U.S. Provisional Application No. 61/317,164, filed Mar. 24, 2010, entitled “Recombinant Knowledge Assimilation Using Knowledge Relatively,” the entire disclosure of which is hereby incorporated by reference.

### BACKGROUND

Transdisciplinary research is a research strategy that crosses disciplinary boundaries to create a holistic approach to problem solving. For example, transdisciplinary research may apply to research efforts, concepts, and/or methods originally developed by one discipline in solving problems arising in one or more other disciplines. One goal of transdisciplinary research is to get members of different fields to work together over time to develop novel concepts and frameworks with potential to produce new approaches which transcend interdisciplinary research.

### SUMMARY

In certain embodiments, a method includes accessing one or more content that each satisfy one or more parameters of a search request. The method further includes determining a plurality of knowledge components associated with the received one or more content objects, the plurality of content objects including a first knowledge component comprising a first discrete portion of information extracted from the one or more content objects and a second knowledge component comprising a second discrete portion of information extracted from the one or more content objects. The method further includes receiving first and second importance factors indicating the relative importance of the first and second knowledge components, respectively. The method further includes determining, based on the first and second importance factors, an association factor indicating the degree to which the first and second knowledge components are related to one another. The method further includes storing the first knowledge component, the second knowledge component, and the determined association as a new content object.

Certain embodiments of the present disclosure may provide one or more technical advantages. For example, the recombinant knowledge assimilation framework of the present disclosure may enhance transdisciplinary research knowledge by facilitating the systematic extraction of tacit and explicit knowledge buried within disparate disciplines and the generation of relative and specific new transdisciplinary knowledge candidates for enhancing other fields of study.

As another example, the recombinant knowledge assimilation framework of the present disclosure may contribute to current and future transdisciplinary researcher. Additionally, the framework may facilitate the visual/structural enhancement of knowledge depiction and collaboration for dissolving silos of rich domain-specific knowledge with little or no knowledge of the domains themselves. Furthermore, the resulting recombined knowledge, including the determined association factors, may be used to standardize and/or model static and dynamic granular dependencies of disciplines and systems, which may allow for dynamic reallocation of components and resources.

As yet another example, the recombinant knowledge assimilation framework of the present disclosure may be optimized internally with the adaptive human cognitive processes for creating systems. Systems built today are often designed to specific functional requirements. Requirement generation may focus on the human cognitive interaction with the system. However, systems themselves generally are not architecturally optimized internally with the adaptive human cognitive processes for creating systems, which potentially can adapt as humans do.

Certain embodiments of the present disclosure may include some, all, or none of the above advantages. One or more other technical advantages may be readily apparent to those skilled in the art from the figures, descriptions, and claims included herein.

### BRIEF DESCRIPTION OF THE DRAWINGS

To provide a more complete understanding of the present disclosure and the features and advantages thereof, reference is made to the following description taken in conjunction with the accompanying drawings, in which:

FIG. 1 illustrates an example system for recombinant knowledge assimilation, according to certain embodiments of the present disclosure;

FIG. 2 illustrates an example structural representation of the relationship between two knowledge components, according to certain embodiments of the present disclosure;

FIG. 3 illustrates an example structural representation of the relationship between two knowledge components, according to certain embodiments of the present disclosure;

FIG. 4 illustrates an example method for recombinant knowledge assimilation, according to certain embodiments of the present disclosure; and

FIGS. 5A-5B illustrate an example recombinant knowledge assimilation process flow associated with the example system for recombinant knowledge assimilation depicted in FIG. 1, according to certain embodiments of the present disclosure.

### DESCRIPTION OF EXAMPLE EMBODIMENTS

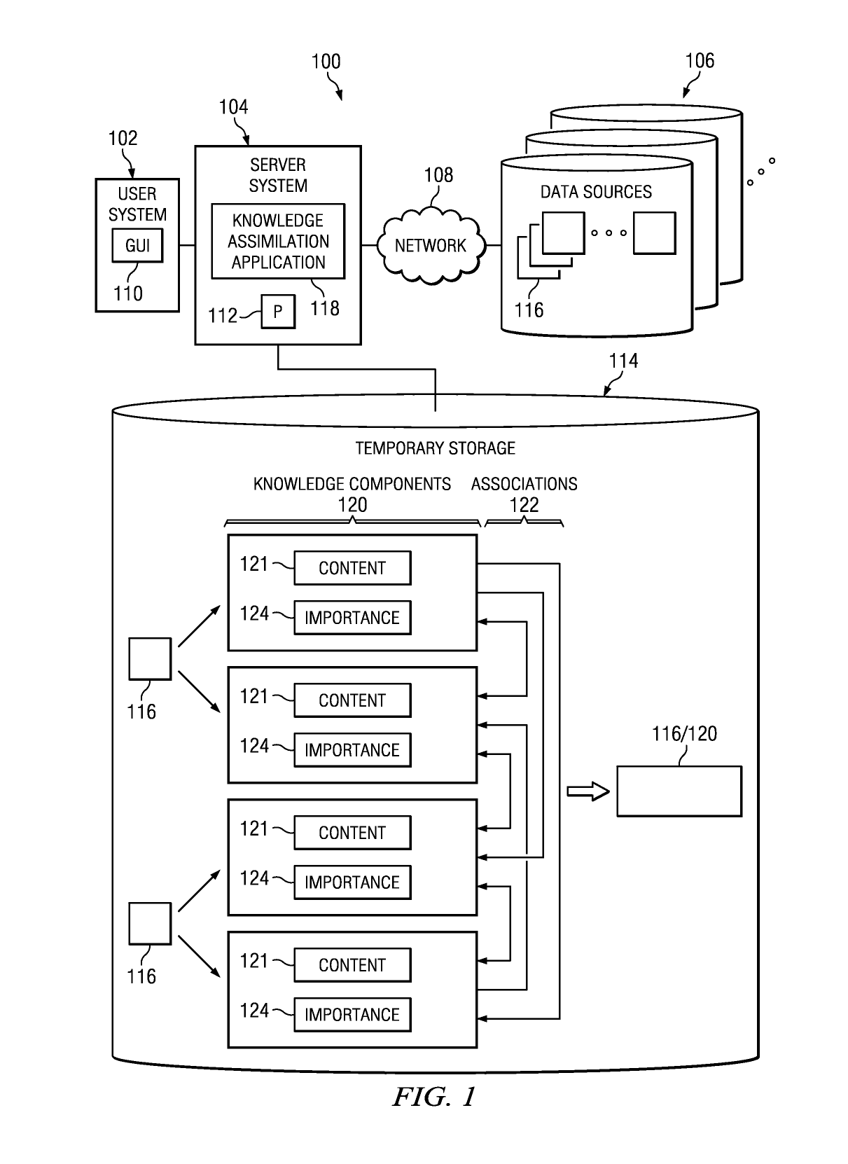

FIG. 1 illustrates an example system 100 for recombinant knowledge assimilation, according to certain embodiments of the present disclosure. System 100 may include one or more user systems 102, one or more server systems 104, one or more data sources 106, and a network 108. Although this particular implementation of system 100 is illustrated and primarily described, the present disclosure contemplates any suitable implementation of system 100 according to particular needs.

In general, system 100 is operable to implement a recombinant knowledge assimilation framework by which disciplinary and transdisciplinary knowledge components and context may be discovered. For example, system 100 may access content objects (e.g., existing publications) deemed relevant to a search request (e.g., a search request received from a user), extract knowledge components from those accessed content objects, and determine the degree to which the extracted knowledge components are associated with one another. The knowledge components and association information, along with context information associated with the extracted knowledge components, may then be stored such that it is available as a content for future search requests. Accordingly, system 100 may provide a mechanism by which users may dynamically interact with ever changing knowledge base, assimilating it to form new knowledge which may be built upon over time.

User systems 102 may include one or more computer systems at one or more locations. Each computer system may include any appropriate input devices (such as a keypad, touch screen, mouse, or other device that can accept information), output devices, mass storage media, or other suitable components for receiving, processing, storing, and communicating data. Both the input device and output device may include fixed or removable storage media such as a magnetic computer disk, CD-ROM, or other suitable media to both receive input from and provide output to a user of user system 102. Each computer system may include a personal computer, workstation, network computer, kiosk, wireless data port, personal data assistant (PDA), one or more processors within these or other devices, or any other suitable processing device. In short, user system 102 may include any suitable combination of software, firmware, and hardware. For simplicity, the one or more user systems 102 are referred to throughout this description primarily in the singular. “User system 102” and “user of user system 102” may be used interchangeably.

User systems 102 may each include one or more processing modules and one or more memory modules. A processing module of a user systems 102 may include one or more microprocessors, controllers, or any other suitable computing devices or resources. Additionally, a processing module of a user system 102 may work, either alone or with other components of system 100, to provide a portion or all of the functionality of system 100 described herein. A memory module of a user system 102 may take the form of volatile or non-volatile memory including, without limitation, magnetic media, optical media, random access memory (RAM), read-only memory (ROM), removable media, or any other suitable memory component.

In certain embodiments, user system 102 may include a graphical user interface (GUI) 110 that allows a user of user system 102 to interact with user system 102 and/or other components of system 100. GUI 110 may be delivered using an online portal or hypertext mark-up language (HTML) pages for display and data capture. For example, GUI 110 may allow user system 102 to interact with components of server system 104 (e.g., knowledge assimilation application 118, described in more detail below). As a particular example, a portion or all of GUI 110 may include a web browser.

User system 102 may be communicatively coupled (e.g., via a network facilitating wireless or wireline communication) to one or more server systems 104 (referred to primarily in the singular throughout the remainder of this description for simplicity). Server system 104 may include one or more electronic computing devices operable to receive, transmit, process, and store data associated with system 100. For example, server system 104 may include one or more general-purpose PCs, Macintoshes, workstations, Unix-based computers, server computers, one or more server pools, or any other suitable devices. In short, server system 104 may include any suitable combination of software, firmware, and hardware. Although referred to as a “server system,” the present invention contemplates server system 104 comprising any suitable type of processing device or devices.

Server system 104 may include one or more processing modules 112 and one or more memory modules 114, each referred to primarily in the singular throughout the remainder of this description. Processing module 112 may include one or more microprocessors, controllers, or any other suitable computing devices or resources. Processing module 112 may work, either alone or with other components of system 100, to provide a portion or all of the functionality of system 100 described herein. Memory module 114 may take the form of volatile or non-volatile memory including, without limitation, magnetic media, optical media, RAM, ROM, removable media, or any other suitable memory component.

Server system 104 may be communicatively coupled to a number of data sources 106 via network 108. Network 108 may facilitate wireless or wireline communication. Network 108 may communicate, for example, IP packets, Frame Relay frames, Asynchronous Transfer Mode (ATM) cells, voice, video, data, and other suitable information between network addresses. Network 108 may include one or more local area networks (LANs), radio access networks (RANs), metropolitan area networks (MANs), wide area networks (WANs), all or a portion of the global computer network known as the Internet, and/or any other communication system or systems at one or more locations.

Data sources 106 may include any suitable repositories accessible via network 108 and storing content objects 116, which may include any suitable documents among which knowledge and context may be developed (e.g. articles, books, images, digital media, notes, journals, or any other suitable document containing information), as described in further detail below. For example, data sources 106 may include one or more databases, each of which may include any memory or database module and may take the form of volatile or non-volatile memory, including, without limitation, magnetic media, optical media, RAM, ROM, removable media, or any other suitable local or remote memory component. As another example, data sources 112 may include websites, web pages within a websites, documents, images, or any other information sources accessible via network 108, according to particular needs.

Server system 104 may include a knowledge assimilation application 118, which may include any suitable combination of hardware, firmware, and software. In certain embodiments, knowledge assimilation application 118 is operable to access a search request. For example, a search request may be received from a user of user system 102. An accessed search request may include a number of search parameters defining the type of information sought by the user of user system 102 from which the request is received. For example, the request parameters may define the types of data sources 106 from which information is sought, the timeframe associated with the information sought, an entity related to the information sought, any other information defining the type of information sought, or any other suitable parameters. As one particular example, a search request may include parameters related to journal abstracts that specifically relate to principles, theories, values, tools, processes, methods, standards, and/or techniques. Although the accessed search request has been primarily described as being a textual input received from a user of user system 102, the present disclosure contemplates that the accessed search request may include any suitable input (e.g., an image file, an audio file sound, or any other suitable information).

In certain embodiments, knowledge assimilation application 118 may be further operable to access one or more content objects 116 (e.g., from data sources 106) that each satisfy one or more of the parameters of an accessed search request. In certain embodiments, the accessed one or more content objects 116 may be temporarily or permanently stored (e.g., in memory module 114 or at any other suitable location in system 100) such that they may be processed by knowledge assimilation application 118, as described below. For example, in embodiments in which the search request includes parameters related to journal abstracts that specifically relate to principles, theories, values, tools, processes, methods, standards, and/or techniques, the accessed one or more content objects 116 may include journal abstracts from seemingly unrelated fields of knowledge (e.g., a video processing abstract and a bioscience abstract). Because knowledge assimilation application 118 may process these seemingly unrelated content objects 116 together (as described in further detail below), new knowledge related to the intersection of the seemingly unrelated fields of knowledge may be generated.

In certain embodiments, knowledge assimilation application 118 may be further operable to extract a number of knowledge components 120 from the accessed one or more content objects 116. For example, in embodiments in which content objects 116 include text (e.g., abstracts, as described above), natural language processing logic, which may be separate from or part of knowledge assimilation application 118, may be used to break the text of the content objects 116 text down into component parts (e.g., words, combinations of words, sentences, or any other suitable component part).

As one particular example, an accessed content object 116 may be a portion of a video processing abstract that includes the following text: “In this paper we propose an effective color filter array (CFA) interpolation method for digital still cameras (DSCs) using a simple image model that correlates the channels.” From this content object 116, and as just an example, knowledge assimilation application 118 may extract five separate knowledge components 120, namely (1) “In this paper,” (2) “we propose an effective color filter array (CFA) interpolation method,” (3) “for digital still cameras (DSCs),” (4) “using a simple image model,” and (5) “that correlates the channels.”

As another particular example, an accessed content object 116 may be a portion of a bioscience abstract that includes the following text: “A phenotypic array method developed for quantifying cell growth was applied to haploid and homozygous diploid yeast deletion strain sets.” From this content object 116, knowledge assimilation application 118 may extract three separate knowledge components 120, namely (1) “A phenotypic array method,” (2) “developed for quantifying cell growth,” (3) “for quantifying cell growth was applied to haploid and homozygous diploid yeast deletion strain sets.”

In certain embodiments, knowledge assimilation application 118 may be further operable to access context information 121 associated with the extracted knowledge components 120. The accessed context information 121 may be any information providing additional information about the extracted knowledge component 120 to which it corresponds and it may be stored in association with that knowledge component 120. In certain embodiments, the context information 121 may be accesses from additional content objects 116 of data sources 106 (e.g., content objects 116 not accessed in response to the received search request).

For example, in the above-described embodiment in which the knowledge component “A phenotypic array method” was extracted from a bioscience abstract content object 116, knowledge assimilation application 118 may access context information 121 comprising definitions for various words of the knowledge component 120. More particularly, for the word “A,” context information 121 defining “A” as “a singular entity” may be accessed (e.g., from a dictionaries or other suitable content objects 116 in a data source 106). Additionally, for the word “phenotypic,” context information 121 defining “phenotypic” as “a representation given by bioscience experts,” “what an organism looks like based upon its gene interacting with the environment,” and “a biochemical representation of an organism” may be accessed (e.g., from a dictionaries or other suitable content objects 116 in a data source 106). Additionally, for the word “array,” context information 121 defining “array” as “an orderly arrangement used in bioscience representation of phenotypes” may be accessed (e.g., from a dictionaries or other suitable content objects 116 in a data source 106).

In certain embodiments, knowledge assimilation application 118 may be further operable to determine a number of association factors 122 for the extracted knowledge components 120 (which include, in some embodiments, accessed context information 121, as described above). Each association factor 122 may describe the relationship between two extracted knowledge components 120.

In certain embodiments, the an association factor 122 for a pair of knowledge components 120 may be determined based on importance factors 124 assigned to the individual knowledge components 120. For example, a user may interact with GUI 114 to view each knowledge component 120 (as well as any context information 121 stored as part of that knowledge component 120) and assign an importance factor 124 to each knowledge component 120. More particularly, a user may grade the level of importance for each knowledge component 120 (e.g., on a scale of 1 to 10) such that each importance factor 124 indicates the user's perceived importance of the knowledge component 120 with regard to the original search request. Although the importance factors 124 are primarily described as being assigned to corresponding knowledge components 120 by user input, the present disclosure contemplates that the importance factors 124 may be assigned to corresponding knowledge components 120 in any suitable manner (e.g., using natural language processing to parse the knowledge components 120 and compare then to the parameters of the accessed search request.

Once an importance factor 124 has been assigned to two knowledge components 120, an association factor 122 indicating the degree to which the two knowledge components 120 are related to one another may be calculated. For example, an association factor may be calculated based on the following equation (which is derived from Newton's law of gravitation):

$$A = B \frac{( {I}_{1} {I}_{2} )}{{c}^{2}}$$

In this equation, A is the association factor 122 (e.g., the magnitude of the attractive force between the two knowledge components 120). B is a balance variable and may be assigned any suitable value; however, for purposes of simplicity it will be assumed throughout the remainder of this description that B=1. I₁ is the importance factor 124 of the first knowledge component 120 and I₂ is the importance factor 124 of the second knowledge component 120, while c is the perceived “closeness” between the two knowledge components 120. For example, c may be a value (e.g., on a scale of 1 to 10) assigned by a user (in a manner similar to that discussed above with regard to importance factors 124) and indicative of the degree to which the two knowledge components are perceived by the user to be related to one another (with a value of 1 being a maximum indication of closeness). Accordingly, the maximum value for an association factor (assuming a scale of 1 to 10 for both importance factors 124 and closeness, as described above) is 100.

As a particular example, association factor 122 may be determined for knowledge components 120 extracted from the bioscience abstract (i.e., content object 116) described above, namely the phrase “A phenotypic array.” The first word of the bioscience abstract is the word “A,” which by itself may have little meaning (although, as more information content is gained and understood, its knowledge value may change). However, it may nevertheless be extracted as a first knowledge component 120 (KC1). All that may be known is that “A” describes a singular entity (based on accessed context information 121, described above) and foreshadows that something will follow. Accordingly, a user may place a small importance factor 124 on KC1 (e.g., importance factor 124=2). The second word of the bioscience abstract, “phenotypic,” may be extracted as a second knowledge component 120 (KC2). Moreover, a user may deem KC2 more important (e.g., based on accessed context information 121) and may therefore allocate a higher importance factor 124 of KC2 (e.g., importance factor 124=4). Furthermore, because KC1 and KC2 reside within the same abstract and one of order sequence, they may be deemed fairly “close” (e.g., closeness value=2). Plugging these numbers into the equation above yields an association factor 122 for KC1 and KC2 of 2 (out of a maximum of 100). In other words, the attraction value between KC1 and KC2 may be deemed fairly low.

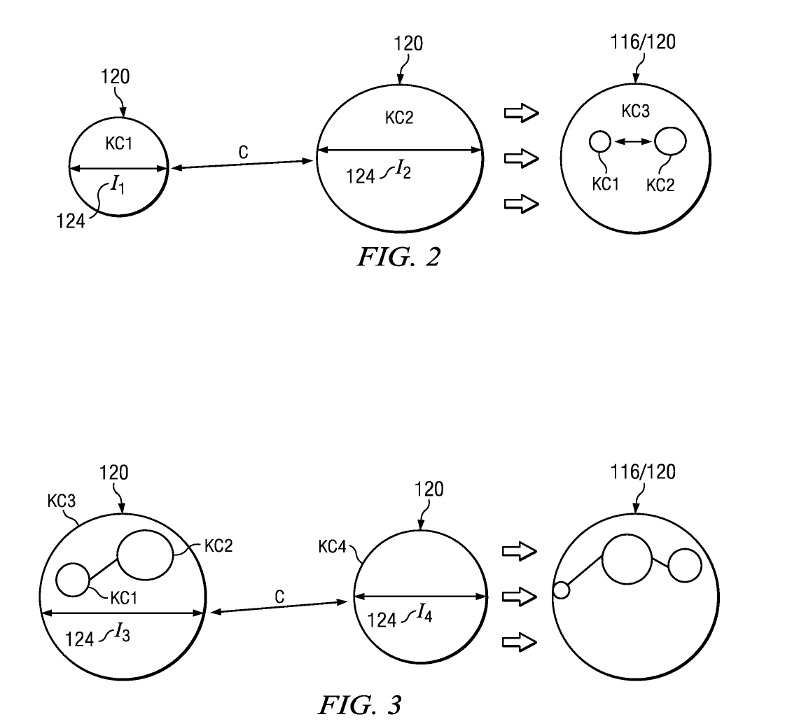

FIG. 2 illustrates a structural representation of the relationship between KC1 and KC2. Because KC1 has a smaller importance factor 124 as compared to KC2, the spheroid for KC1 is represented as smaller than that of KC2 (i.e., diameter, I₁<I₂). The line distance between KC1 and KC2 structurally represents “closeness,” the perception as to closely related the knowledge components are to one another.

In certain embodiment, the determined association factor 122, along with the knowledge components 122 (KC1 and KC2), the context information 121, and/or the importance factors 124, may be stored as a new content object 116 (e.g., in a data source 106) such that future researches may built upon the extracted knowledge contained therein. Additionally or alternatively, the determined association factor 122, along with the knowledge components 122 (KC1 and KC2), the context information 121, and/or the importance factors 124, may be treated as a new knowledge component 122 so that an association factor between it and other knowledge components 122 may be determined (as described below).

Continuing with the above-described example, KC1 and KC2 may be combined into a single knowledge component 120 (which includes any context information 121 as well as the association factor 122, described above) (KC3). The next word in the bioscience abstract, the word “array,” may be extracted as a second knowledge component 120 (KC3). Repeating the process described above, an association factor 122 for this second set of knowledge components 120 may be determined. Because discovery of phenotypes were known to be considered valuable bioscience information, a user may allocate an importance factor 124 of 5 to KC3 (the value may not be greater than 5 because the user may believe that other items may have existed which could have been of more value). If information was later discovered that revealed that the allocated importance factor 124 of 5 was inappropriate, then the value would be refined at that juncture based upon the knowledge and context found. Furthermore, because it may not be known how “array” (KC4) relates to “A phenotypic” (KC1), the importance factor 124 for KC4 may be initialized to 1. If, however, context information 121 is uncovered that indicates that arrays are used as important tools in bioscience research, the value of the importance factor 124 for KC4 may be increased (e.g., to 3, based on a belief that arrays are important tools in bioscience research, but not necessarily as important as phenotypes). Additionally, because “A phenotypic array” (i.e., the combination of KC3 and KC4) is an important bioscience domain method, a closeness value of 1 may be allocated (indicating a small distance and hence a very close relationship). Plugging these numbers into the equation above yields an association factor 122 for KC3 and KC4 of 15 (out of a maximum of 100). In other words, the attraction value between KC3 and KC4 may be deemed fairly low, but greater than that for KC1 and KC2 (described above).

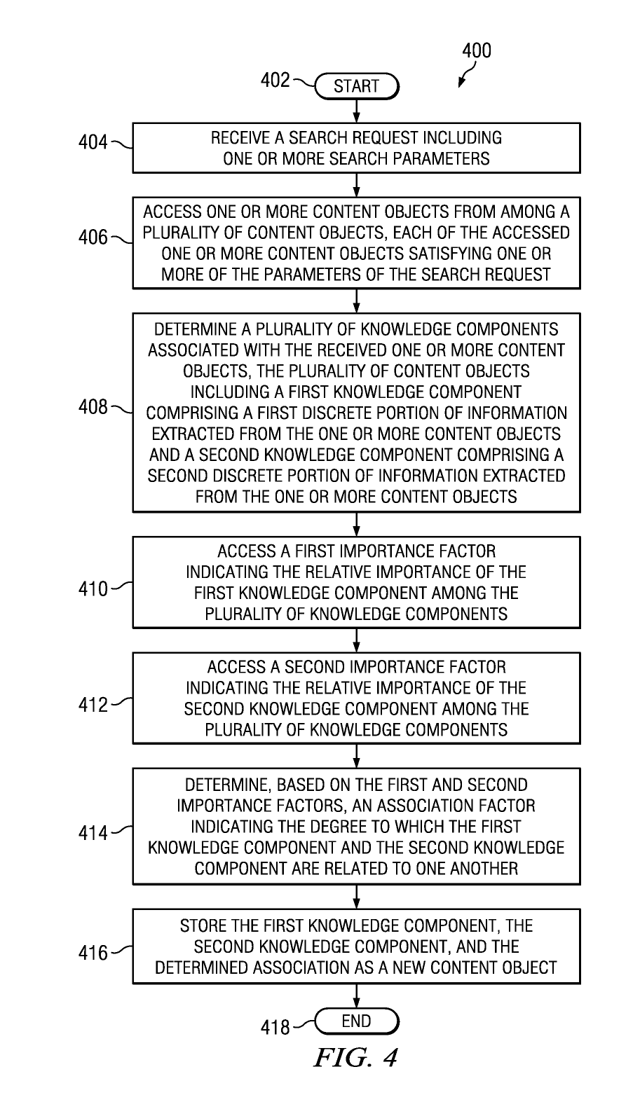

FIG. 3 illustrates a structural representation of the relationship between KC3 and KC4. Because KC3 has a larger importance factor 124 as compared to KC4, the spheroid for KC3 is represented as larger than that of KC4 (i.e., diameter, I₃>I₄). The line distance between KC3 and KC4 structurally represents “closeness,” the perception as to closely related the knowledge components are to one another.

In certain embodiment, the determined association factor 122, along with the knowledge components 122 (KC3 and KC4), the context information 121, and/or the importance factors 124, may be stored as a new content object 116 (e.g., in a data source 106) such that future researches may built upon the extracted knowledge contained therein. Additionally or alternatively, the determined association factor 122, along with the knowledge components 122 (KC3 and KC4), the context information 121, and/or the importance factors 124, may be treated as a new knowledge component 122 so that an association factor between it and other knowledge components 122 may be determined.

Knowledge assimilation application 118 may iteratively repeat the above-described processes (i.e., comparing knowledge components 120 extracted from various content objects 116 to determine association factor 122 grading the relationships between those knowledge components) in order to extract new knowledge from accessed content objects. That new knowledge (in the for of extracted knowledge components 120, importance factors 124 associated with those knowledge components 120, and determined association factors 122) may then be stored as new content objects 116 (e.g., in a data source 106). Accordingly, these new content objects may be accessed in response to future search requests and new knowledge from a variety of disciplines may be generated over time.

Certain embodiments of system 100 may provide one or more technical advantages. For example, system 100 may enhance transdisciplinary research knowledge by facilitating the systematic extraction of tacit and explicit knowledge buried within disparate disciplines and the generation of relative and specific new transdisciplinary knowledge candidates for enhancing other fields of study.

As another example, system 100 may contribute to current and future transdisciplinary researcher. Additionally, the framework may facilitate the visual/structural enhancement of knowledge depiction and collaboration for dissolving silos of rich domain-specific knowledge with little or no knowledge of the domains themselves. Furthermore, the resulting recombined knowledge, including the determined association factors, may be used to standardize and/or model static and dynamic granular dependencies of disciplines and systems, which may allow for dynamic reallocation of components and resources.

As yet another example, system 100 may be optimized internally with the adaptive human cognitive processes for creating systems. Systems built today are often designed to specific functional requirements. Requirement generation may focus on the human cognitive interaction with the system. However, systems themselves generally are not architecturally optimized internally with the adaptive human cognitive processes for creating systems, which potentially can adapt as humans do.

Although a particular implementation of system 100 is illustrated and primarily described, the present disclosure contemplates any suitable implementation of system 100 according to particular needs. Furthermore, although a particular number of components of system 100 have been illustrated and primarily described above, the present disclosure contemplates system 100 including any suitable number of such components.

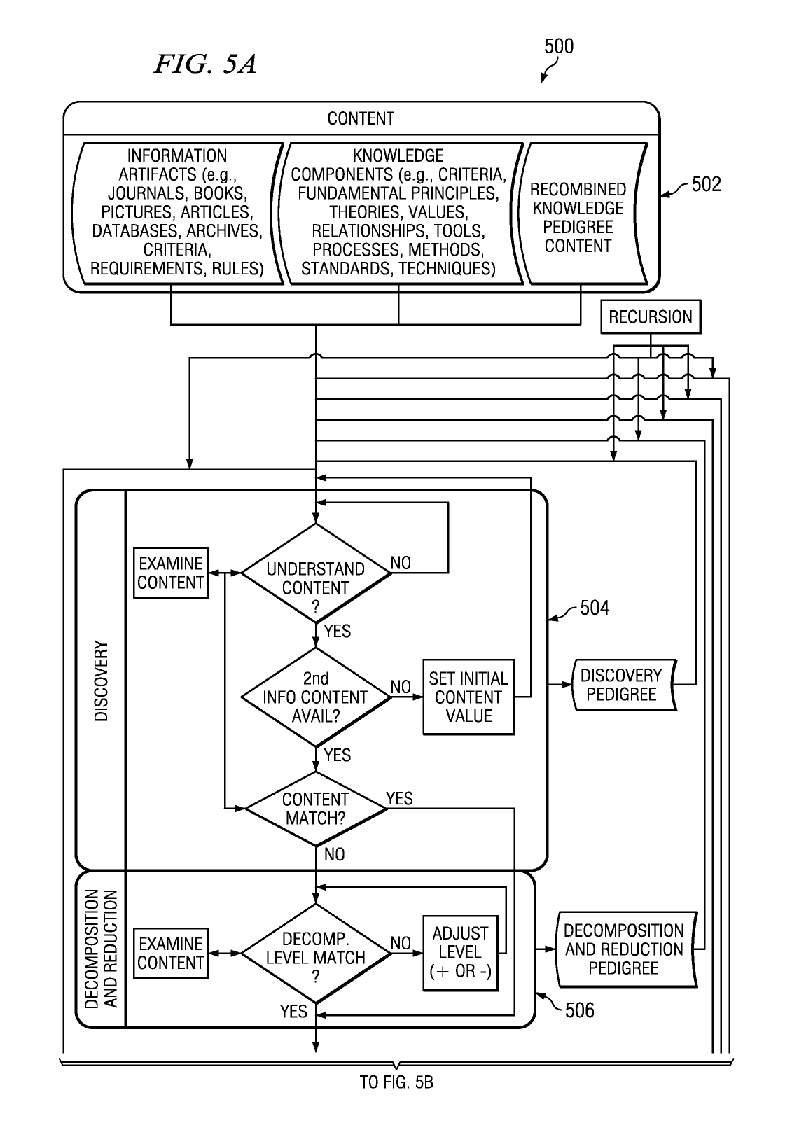

FIG. 4 illustrates and example method 400 for recombinant knowledge assimilation, according to certain embodiments of the present disclosure. The method begins at step 402. At step 404, knowledge assimilation application 118 receives a search request including one or more search parameters (e.g., from a user of user system 102). At step 406, knowledge assimilation application 118 accesses one or more content objects 116 from among a plurality of content objects 116 (e.g., stored in a data source 106). Each of the accessed content objects 116 may satisfy one or more of the parameters of the search request.

At step 408, knowledge assimilation application 118 determines a plurality of knowledge components 120 associated with the received one or more content objects 116. For example, in embodiments in which content objects 116 include text (e.g., abstracts, as described above), natural language processing logic, which may be separate from or part of knowledge assimilation application 118, may be used to break the text of the content objects 116 text down into component parts (e.g., words, combinations of words, sentences, or any other suitable component part) each comprising a knowledge component 120. In particular, knowledge components 120 include at least a first knowledge component 120 comprising a first discrete portion of information extracted from the one or more content objects 116 and a second knowledge component 120 comprising a second discrete portion of information extracted from the one or more content objects 116.

At step 410, knowledge assimilation application 118 accesses a first importance factor 124 indicating the relative importance of the first knowledge component 120 among the plurality of knowledge components 120. At step 412, knowledge assimilation application 118 accesses a second importance factor 124 indicating the relative importance of the second knowledge component 120 among the plurality of knowledge components 120. For example, a user may interact with GUI 114 to view each knowledge component 120 (as well as any context information 121 stored as part of that knowledge component 120, as described above) and assign an importance factor 124 to each knowledge component 120. More particularly, a user may grade the level of importance for each knowledge component 120 (e.g., on a scale of 1 to 10) such that each importance factor 124 indicates the user's perceived importance of the knowledge component 120 with regard to the original search request.

At step 414, knowledge assimilation application 118 determines an association factor 122 indicating the degree to which the first knowledge component 120 and the second knowledge component 120 are related to one another, the association factor 122 being determined based in the importance factors 124 allocated to the first and second knowledge components 120.

At step 416, knowledge assimilation application 118 stores the first knowledge component 120, the second knowledge component 120, and the determined association factor 122 (along with any context information 121, described above) as a new content object 116 (e.g., in a data source 106).

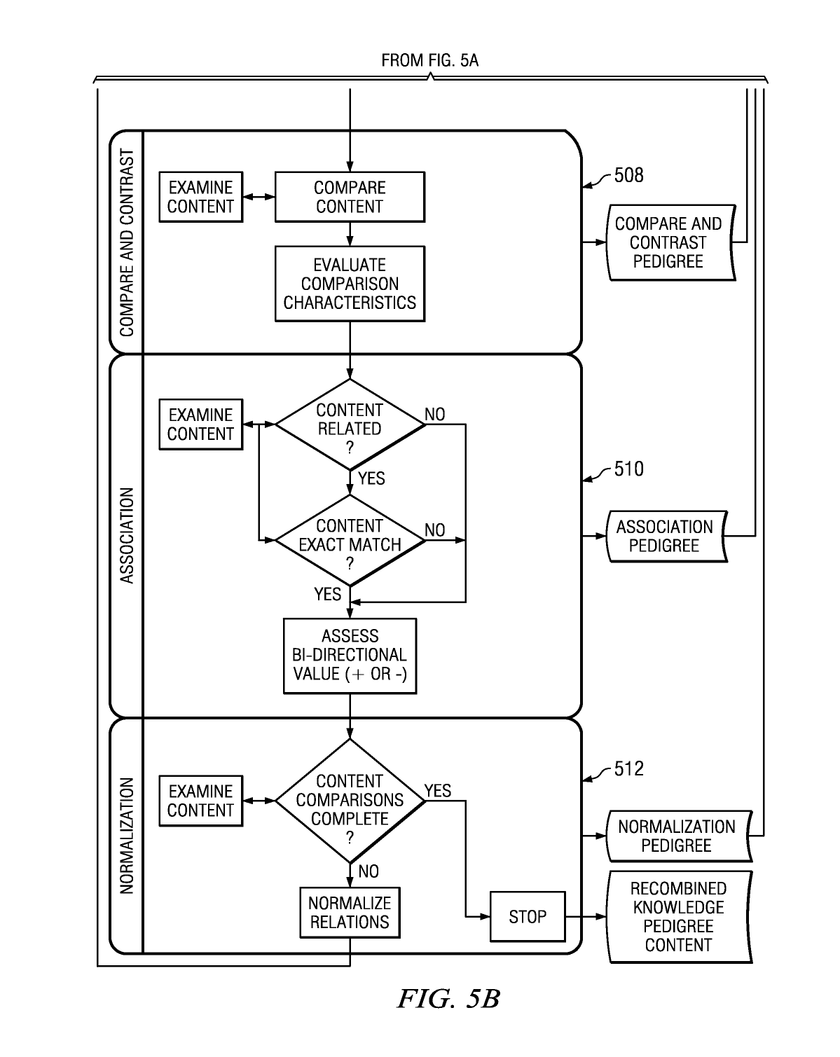

FIGS. 5A-5B illustrate an example recombinant knowledge assimilation process flow 500 associated with the example system 100 for recombinant knowledge assimilation, according to certain embodiments of the present disclosure. The recombinant knowledge assimilation process flow 500 begins when a reason or need was established to ask a question and to want to search for an answer. This causes the establishment of a set of criteria or rules which govern what was to be discovered (e.g., a search request comprising a number of search parameters is generated). These search parameters govern the activity performing the bottom-up processing and recursively evolving the building of knowledge and context. Once the criteria has been established and understood, the recombinant knowledge assimilation sub-processes begin processing based upon the defined rules.

Recombinant knowledge assimilation processes search parameters just as other information content (e.g., content objects 116). Each is collected from the Information Domain (e.g., a data source 106), processed (e.g., by knowledge assimilation application 118, as described above, and subsequently placed back into the Knowledge Domain for subsequent use. Box 502, labeled “Content,” represents all information content which can potentially be used when performing the steps of the recombinant knowledge assimilation process to build knowledge (inclusive of data sources 106, user input, and/or any other source of information).

The recombinant knowledge assimilation process flow 500 additionally contains five functional sub-processes, labeled Discovery sub-process 504, Decomposition and Reduction sub-process 506, Compare & Contrast sub-process 508, Association sub-process 510, and Normalization sub-process 512. Discovery sub-process 504 encompasses the review and understanding of existing knowledge and/or, in the case of disciplines, the review of a discipline's fundamentals and/or principle. Decomposition and Reduction sub-process 506 decomposes the domain knowledge into “bite size” digestible bits of information and reduces the representative domain knowledge to a core capability (e.g., via the extraction of knowledge components 120 from content objects 116). Compare & Contrast sub-process 508 encompasses a cognitive examination process assimilating facts and information, comparing each to the other, and looking for evolving associations. Association sub-process 510 encompasses the establishing and assigning of relationships between any two knowledge components 120 (e.g., by determining association factors 122). Normalization sub-process 512 encompasses the process of combining commonalities into a normalized form and validating the result.

The recombinant knowledge assimilation process flow 500 additionally includes a recursion aspect (depicted as feedback loops), which represents the iterative recursive refinement taking the knowledge gathered during each iteration and using it as input into the next iteration of the recombinant knowledge assimilation process. Recursion is well suited for the goal of creating knowledge components 120 using a bottom-up approach, iteratively building its components and attributes through a series of decisions. Hence, recombinant knowledge assimilation process flow 500 implements the mature bottom-up approach for developing knowledge and context as discipline components, derived from discipline domain abstract readings and the recursive nature of the process shown by the feedback loop, which recombines knowledge and context.

In the Discovery sub-process 504, a user must gather at least one additional piece of information content to make a comparison. During the comparison process, the user may ask questions and develop answers, with empirical information being developed and retained during each specific step. For example, the value (i.e., importance factor) a user places upon each piece of information content (i.e. knowledge component 120), shown in Discovery step 4, can be temporarily saved to retain the context of the thoughts being developed. After the first piece of content (i.e., knowledge component 120) has been observed and value (e.g., by allocating an importance factor 124), the flow diagram shows that a user may have at least one other piece of information content (i.e., knowledge component 120) in order to form a comparison. Hence, recombinant knowledge assimilation process flow 500 continues back to Discovery step 1 to observe a second piece of information content in order to form a comparison. If the user has found two pieces of content that are believed to be an exact match and are exactly what has been searched for, then the flow resumes in the Association sub-process 510 where a determination was made as to the association factor 122 between the two pieces of content. If there was not an exact match, then flow proceed to the Decomposition and Reduction sub-process 506.

In the Decomposition and Reduction sub-process 506, decomposition expands the recombinant knowledge assimilation flow diagram 500 (as shown in box 2) and constitutes the act of slicing the contextual bonds of a relationship between two pieces of information and comparing the logical context level to assess whether information content should be further sliced or whether information content should be aggregated. For example, a document can be sliced into paragraphs and paragraphs can be sliced into sentences. In other words, the knowledge components 116 initially extracted from accessed content objects 116 may be further broken down into knowledge components 116 of finer granularity. Alternatively, knowledge components 116 initially extracted from accessed content objects 116 may be aggregated together into knowledge components 116 of coarser granularity. At the box labeled “Adjust Layer Up or Down,” a user may decide whether the content being compared was at the same logical context level and may choose to aggregate or decompose the information that was gathered/extracted initially. Any new context, knowledge or information content is generated at this point may then be fed back into content repository 502. The reasoning captured during decomposition may give valuable insight into the user context. For example, it is well known that words can have multiple definitions, and when they are aggregated together into sentence form they can portray different emphasis and meanings just by their sequence. Therefore, capturing this as pedigree provides the next evaluator of this information valuable reasoning context which could otherwise easily be misinterpreted.

In the Compare & Contrast sub-process 508, simple interrogatories such as, Who, What, When, Where, How, and Why (as well as more detailed questions) can be asked based upon the context to determine relationship specifics.

In the Association sub-process 510, an association factor 122 may be determined, the association factor 122 valuing the relationships formed during recombinant knowledge assimilation. Based upon the analysis captured during Compare and Contrast sub-process 508, the degree to which knowledge components 120 being compared are related to one another may be determined. As in all the previous sub-processes, the iterative decisions and reasoning is captured fed back into the content repository 502.

In the Normalization sub-process 512, the overall content of the relationships developed under a set of rules governing what to discover may be evaluated. In this sub-process, relationships created under the guise of a given criteria context may be compared to each other bi-directionally. If all comparisons are complete, then the recombinant knowledge assimilation process flow diagram process stops and the Normalization pedigree is added to the content repository 502. The pedigree reasoning which was derived from normalizations of the all the relationships created under a certain criteria are related to each other to achieve a cohesive overall value chain of the relationships to each other and their importance to the overall context of the criteria.

Although the present disclosure has been described with several embodiments, diverse changes, substitutions, variations, alterations, and modifications may be suggested to one skilled in the art, and it is intended that the disclosure encompass all such changes, substitutions, variations, alterations, and modifications as fall within the spirit and scope of the appended claims.

What is claimed is:

1. A computer-implemented method, comprising:
accessing, using one or more processing modules, one or more content objects from among a plurality of content objects, each of the accessed one or more content objects satisfying one or more parameters of a search request;
determining, using the one or more processing modules, a plurality of knowledge components associated with the received one or more content objects, the plurality of knowledge components including:
a first knowledge component comprising a first discrete portion of information extracted from the one or more content objects; and
a second knowledge component comprising a second discrete portion of information extracted from the one or more content objects;
accessing, using the one or more processing modules, a first importance factor indicating the relative importance of the first knowledge component among the plurality of knowledge components;
accessing, using the one or more processing modules, a second importance factor indicating the relative importance of the second knowledge component among the plurality of knowledge components;
determining, using the one or more processing modules and based on the first and second importance factors, an association factor indicating the degree to which the first knowledge component and the second knowledge component are related to one another; and
storing, using the one or more processing modules, the first knowledge component, the second knowledge component, and the determined association factor as a new content object.

2. The computer-implemented method of claim 1, wherein the new content object is stored in association with the search request.

3. The computer-implemented method of claim 1, wherein at least one of the accessed one or more content objects comprises a previous new content object stored in association with a previous search request.

4. The computer-implemented method of claim 1, wherein the first and second knowledge components are extracted from the one or more content objects using natural language processing.

5. The computer-implemented method of claim 1, wherein accessing the first and second importance factors comprises receiving the first and second importance factors from a user input.

6. The computer-implemented method of claim 1, further comprising:
determining first context information associated with the first knowledge component, the first context information being extracted from a first additional content object accessed from among the plurality of content objects; and
determining second context information associated with the second knowledge component, the second context information being extracted from a second additional content object accessed from among the plurality of content objects.

7. The computer-implemented method of claim 6, further comprising storing the first and second context information as part of the new content object.

8. The computer-implemented method of claim 1, wherein:
the accessed one or more content objects comprise written articles; and
the plurality of knowledge components each comprise a string of one or more words included in the written articles.

9. A system, comprising:
one or more memory modules operable to store a plurality of content objects;
one or more processing modules operable to:
access one or more content objects from among the plurality of content objects, each of the accessed one or more content objects satisfying one or more parameters of a search request;
determine a plurality of knowledge components associated with the received one or more content objects, the plurality of knowledge components including:
a first knowledge component comprising a first discrete portion of information extracted from the one or more content objects; and
a second knowledge component comprising a second discrete portion of information extracted from the one or more content objects;
access a first importance factor indicating the relative importance of the first knowledge component among the plurality of knowledge components;
access a second importance factor indicating the relative importance of the second knowledge component among the plurality of knowledge components;
determine, based on the first and second importance factors, an association factor indicating the degree to which the first knowledge component and the second knowledge component are related to one another; and
store the first knowledge component, the second knowledge component, and the determined association factor as a new content object.

10. The system of claim 9, wherein the new content object is stored in association with the search request.

11. The system of claim 9, wherein at least one of the accessed one or more content objects comprises a previous new content object stored in association with a previous search request.

12. The system of claim 9, wherein the first and second knowledge components are extracted from the one or more content objects using natural language processing.

13. The system of claim 9, wherein accessing the first and second importance factors comprises receiving the first and second importance factors from a user input.

14. The system of claim 9, wherein the one or more processing modules are operable to:
determine first context information associated with the first knowledge component, the first context information being extracted from a first additional content object accessed from among the plurality of content objects; and
determine second context information associated with the second knowledge component, the second context information being extracted from a second additional content object accessed from among the plurality of content objects.

15. The system of claim 14, wherein the one or more processing modules are operable to store the first and second context information as part of the new content object.

16. The system of claim 9, wherein:
the accessed one or more content objects comprise written articles; and
the plurality of knowledge components each comprise a string of one or more words included in the written articles.

17. Software embodied on a non-transitory computer readable medium, the software operable when executed to:
access one or more content object from among a plurality of content objects, each of the accessed one or more content objects satisfying one or more parameters of a search request;
determine a plurality of knowledge components associated with the received one or more content objects, the plurality of knowledge components including:
a first knowledge component comprising a first discrete portion of information extracted from the one or more content objects; and
a second knowledge component comprising a second discrete portion of information extracted from the one or more content objects;
access a first importance factor indicating the relative importance of the first knowledge component among the plurality of knowledge components;
access a second importance factor indicating the relative importance of the second knowledge component among the plurality of knowledge components;
determine, based on the first and second importance factors, an association factor indicating the degree to which the first knowledge component and the second knowledge component are related to one another; and
store the first knowledge component, the second knowledge component, and the determined association factor as a new content object.

18. The software of claim 17, wherein the new content object is stored in association with the search request.

19. The software of claim 17, wherein at least one of the accessed one or more content objects comprises a previous new content object stored in association with a previous search request.

20. The software of claim 17, wherein the first and second knowledge components are extracted from the one or more content objects using natural language processing.

21. The software of claim 17, wherein accessing the first and second importance factors comprises receiving the first and second importance factors from a user input.

22. The software of claim 17, wherein the software is operable when executed to:
determine first context information associated with the first knowledge component, the first context information being extracted from a first additional content object accessed from among the plurality of content objects; and
determine second context information associated with the second knowledge component, the second context information being extracted from a second additional content object accessed from among the plurality of content objects.

23. The software of claim 22, wherein the software is operable when executed to store the first and second context information as part of the new content object.

24. The method of claim 17, wherein:
the accessed one or more content objects comprise written articles; and
the plurality of knowledge components each comprise a string of one or more words included in the written article.
